(19) United States
(12) Patent Application Publication
(10) Pub. No.: US 2022/0067742 A1
(43) Pub. Date: Mar. 3, 2022

(54) Method and system for flexible purchases using only biometrics at the time and location of purchase

(71) Applicant: Rania Abouyounes, Windsor (CA)

(72) Inventor: Rania Abouyounes, Windsor (CA)

(21) Appl. No.: 17/004,923

(22) Filed: Aug. 27, 2020

(51) Int. Cl. G06Q 20/40; G06Q 20/22

(52) U.S. Cl. CPC G06Q 20/40145; G06Q 20/227; G06Q 20/405

(57) ABSTRACT

A method and system for flexible payments to enable buyers to pay for goods and services using only their biometrics at the time and location of purchase. The method is based on buyers registering their biometrics and one or more payment methods such as financial credit cards and relating one or more of their biometrics to one or more registered convenient rules that will act on behalf of buyers at the time of purchase to select the payment method based on purchase conditions such as purchase amount, purchase location and purchase time. Buyers can also enable external rules such as promotions to automatically become convenient rules to select from registered payment methods on behalf of the buyer at the time of purchase.

### FIELD OF THE INVENTION

The invention is related to the flexible and quick purchase of goods and services using the biometrics of buyers.

### BACKGROUND OF THE INVENTION

Most people own credit or debit cards that allow them to charge payments when buying goods and services or withdrawing cash from automated teller machines (ATM). Card holders have to carry their cards and present them at cash registers or insert them into ATMs. The cards are swiped into special devices that can read the data embedded on the card and send the data in addition to the payment amount to the payment authority to validate the card data and available money balance on the card. In the case of credit cards, the payment is automatically charged to the account and the card holder signs a payment receipt to authorize the payment. In the case of debit cards, the card holder enters a personal identification number (PIN) that must match a previously stored PIN on the payment authority. There are also prepaid cards that hold a prepaid amount of money or in the case of cash where payment is the quickest without the need to sign a receipt or enter a PIN.

One common disadvantage of all of these types of payment methods is that they all have to be physically carried with the buyer whenever they are used. This creates a risk to buyers as the cards or cash could be lost, stolen, damaged or fraudulently obtained. Also, signatures could be forged and PINs could be forgotten. Furthermore, some payment methods have promotions and special discounts depending on the amount, location or time of purchase that can be missed at the time of purchase.

In one attempt to further identify card holders, biometric information in the form of fingerprints or face recognition has been heavily explored. Fingerprints and face features are unique and can easily be read by fingerprint readers and camera devices that are commercially available. Biometrics in general can also be collected from buyers when they obtain or activate their credit or debit cards. Much of the art that employ biometrics in financial transactions have been circulating around replacing signatures and PINs with fingerprints that could uniquely identify buyers and authorize payments. Such biometric data could be embedded on the card in some form and the extracted biometric data from buyers at the time of purchase can be matched against stored biometric data to find a match. However, most of these patents do not address the issue of physically carrying a credit or debit card when making a purchase or money withdrawal and neither do they address any outstanding promotions or special discounts that would favor one payment method over another. When physically carrying cards or checks to make a purchase, the account information is sent from the purchase location and transmitted to the remote payment institution to charge the account. If a shopper wants to visit more than one store then they may need to use the card issued by such particular stores instead of a generic card which could be inconvenient for shoppers. Furthermore, combining biometrics with financial cards or accounts along with the available promotions for such cards or accounts requires a system at the location of purchase where a card reader and a biometric reader are needed.

A search of prior art did not disclose any patents that read directly on the claims of this invention. This patent application builds upon my issued U.S. Pat. No. 7,604,166 titled Method and system for flexible purchases using only fingerprints at the time and location of purchase.

### SUMMARY OF THE INVENTION

The method and systems in this invention makes use of biometrics as the only physical mean needed to purchase goods and services at the time and location of purchase. Many proposals have been made to employ the unique characteristic of biometric data such as fingerprints and face recognition as an identification or authorization mechanism in addition to presenting a card at the time and location of purchase where biometrics are intended to securely and uniquely identify buyers. This method is different as it uses biometrics alone to make a purchase and no account information is presented at the location of purchase. The method also allows buyers to associate one or more biometrics to one or more financial cards and accounts by allowing buyers to register and relate one or more convenient rules to one or more biometrics where the system can automatically use the registered convenient rues to select and charge one of the financial cards or accounts at the time of purchase. Eliminating the need for cards or checks while shopping adds the flexibility and security to shopping where buyers can specify when and where to use their financial cards and accounts in relation to their biometrics. This method also reduces the risk of financial cards and accounts from being misused, lost or forged where buyers can use convenient rules to direct the system into selecting the appropriate payment method only when biometric matches a registered biometric and the conditional part of one of the pre-registered convenient rules is satisfied for certain purchase conditions such as the purchase amount, purchase time and/or location. Even if the biometric of a buyer who uses this method is comprehend, this method provides protection to the buyer where one conditional part of one of the convenient rules need to be satisfied for a payment method to be selected to pay for the purchase. For example, a purchase amount can be charged to a different card based on the purchase amount or a special card can be charged based on the location of the purchase. Buyers can associate different cards to different biometrics as they wish. Buyers can also use their billing address information as a payment method where the system can collect the purchases and bill buyers at regular times. Buyers can receive promotions to encourage them to use one payment method over another and they do not want to miss out on getting additional discounts on their purchase. There are many companies that already have systems that are able to link biometrics readers to large biometrics databases to quickly authenticate users. Furthermore, there have been many proposals to associate biometrics with financial cards as a method of payment. The method of this invention is different in three aspects.

The first aspect of the invention is to provide buyers, prior to their first purchase, the ability to protect how their payment methods are being used. This ability is provided when a buyer tries to associate or relate one or more biometrics with one or more of his or her payment methods (e.g. financial cards and accounts). This relationship is indirect because there are registered convenient rules that are rather directly related to one or more registered biometrics. Each rule has an action component that directs the system into selecting one or more payment methods when the conditional component of such rule is satisfied. The conditional component is where the buyer can specify what purchase amount is permitted as well as which purchase location and at what time this purchase can be allowed and when these conditions are satisfied for that specific purchase time and location then one or more registered payment methods that are defined in the action component of the rule can be selected to pay for the purchase as defined by the buyer. At least one of the registered convenient rules will need to fire meaning that its conditional component is satisfied for the purchase to continue which means that the purchase is bound to the buyer rules even if the correct biometrics was presented at the time of purchase.

The second aspect of the invention is when the system acts on behalf of buyers at the time of purchase using previously stored convenient rules to select and charge one or more registered payment methods. When buyers attempt to purchase goods and services, they are prompted to scan their biometrics using a biometric reader as the only proof of identity and method of payment. The system tries to match the scanned biometric with the stored biometric(s). If a match is found, the system tries to on behalf of the buyer to use the purchase amount and purchase time and location that are only known at the time of purchase to evaluate the conditional components of all convenient rules that were previously registered and related to the matched biometric. When at most one of the conditional components of any rule is satisfied, the system will use the action component of such rule as previously defined by the buyer to select one or more of the registered payment methods.

The third aspect of the invention is when the system receives external rules in the form of promotions from the account issuing entity of the buyer's financial payment methods (e.g. where if the buyer uses that financial payment method to pay for a purchase of a specific amount during the promotion period for a specific merchant then he would get some type of promotion such as a purchase amount discount, cash back, double points on the credit card or free gift. Since the buyer may not keep track of such promotions all the time to set his convenient rules properly, the system can dynamically receive such promotions and process them instead of the registered convenient rule(s) with the buyer's prior acceptance to such process. This will ensure that the buyer is always getting the best deal and not missing out on timely promotions.

### BRIEF DESCRIPTION OF THE DRAWINGS

FIG. 1 shows the biometric registration process of the present invention;

FIG. 2 shows the purchase process of the present invention;

FIG. 3 is a schematic diagram illustrating a system that incorporates a method in accordance with one embodiment of the present invention; and

FIG. 4 is a block diagram illustrating the interaction of the system in FIG. 3 with other systems.

FIG. 5 is an example of Convenient Rules and External Rules.

### DETAILED DESCRIPTION OF THE ILLUSTRATED EMBODIMENTS

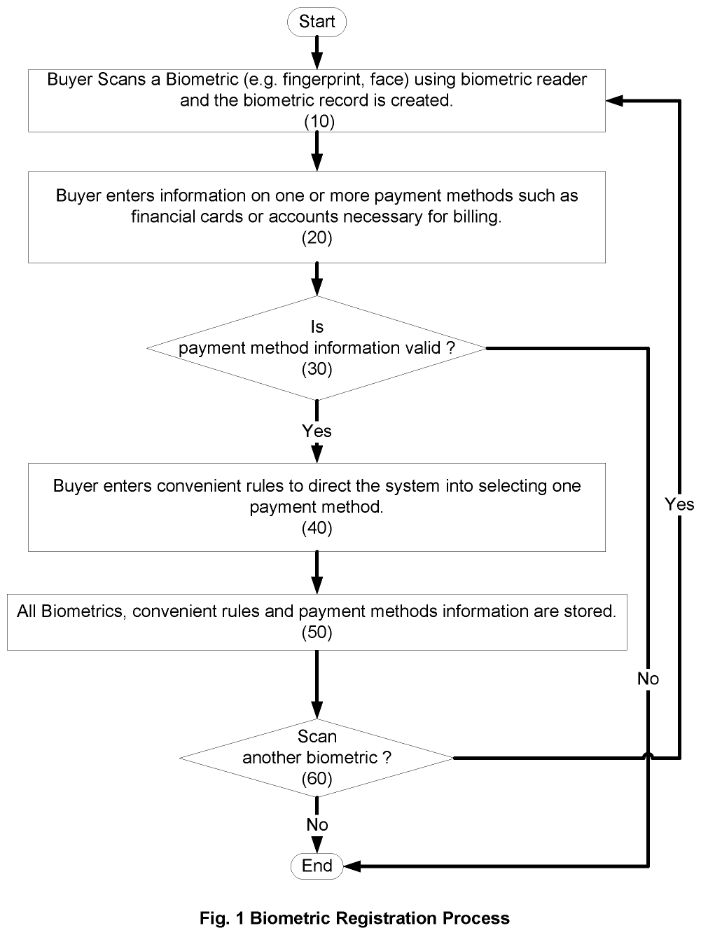

A simple process flow that can occur prior to the first purchase when using this proposed method is shown in FIG. 1 where the buyer attempts to scan his biometric using a biometric reader and the biometric record is created (10). The buyer then enters all information necessary to process payments for each payment method (20). For example, if the payment method is a Credit Card the information could be the card number, expiration date and name on the card. In case of financial bank accounts, it could be the checking account number, bank information and name on the account. The buyer can use a bill me later type method and just enter the billing address information and other related personal information. The buyer can also deposit cash and use a pre-paid type account. In general, all methods of payments could be used. An initial validation could be performed to ensure that the payment method information is valid (30) and this could be done in many ways where the card and account issuing party could be contacted to request a validation or a communication could be sent in the form of mail to validate the name and address on the account. Buyers can setup convenient rules (40) to direct the system into selecting the best payment method depending on information and conditions known at the time of purchase (e.g. purchase amount, purchase time, purchase location). For example, a buyer may want to always use a pre-paid cash account for purchases less than a specific amount or a buyer may want to charge a specific card when shopping at a specified store. All information is stored (50) to be used at the time of purchase. The system can prompt the buyer to scan another biometric (60) and repeat the process. Other biometrics can map to the same list of convenient rules.

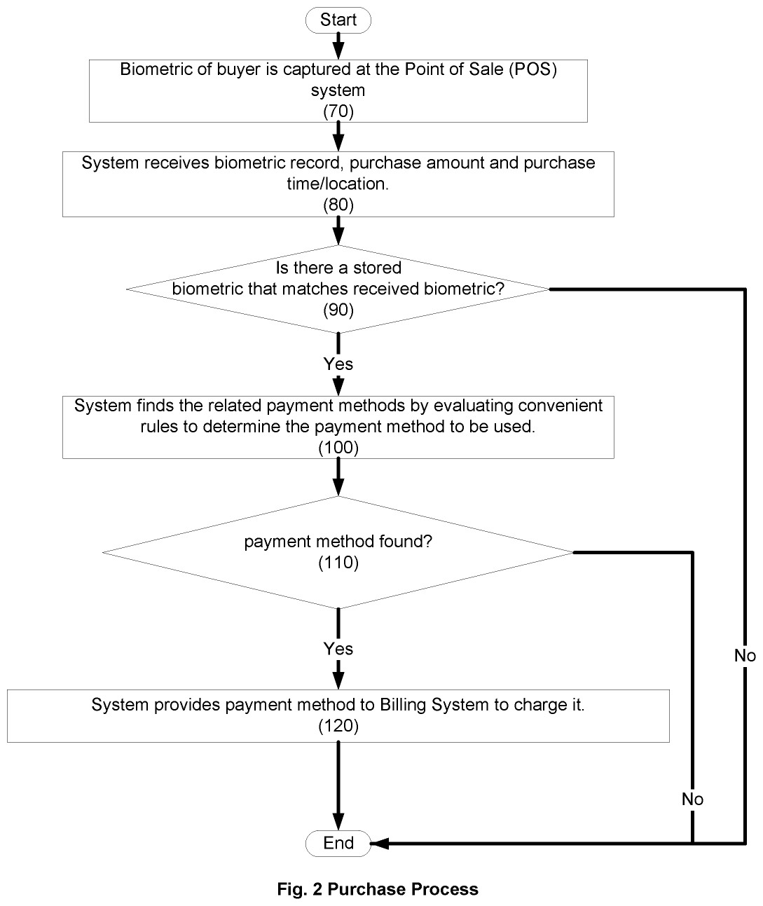

FIG. 2 shows an example of a purchase process where the system is processing the payment on behalf of the buyer. When the buyer is ready to pay for his purchase, the buyer scans his biometric using a biometric reader and the Point of Sale (POS) system located at the purchase location captures the biometric record (70). The POS system sends the biometric data, purchase amount and other available data to the biometric registration system (80). The system receives the biometric data and tries to match it against existing biometrics (90). If no match is found then the purchase can not be completed. If a match is found, the system executes the previously stored convenient rules and other external rules related to the biometric record to try and select the appropriate payment method that can be used (100). If the system does not find a stored payment method that can be used for this purchase (110) then the purchase can not be completed otherwise the system uses the found payment method to contact the appropriate billing system and charge the selected card or debit account and return status back to the POS system (120).

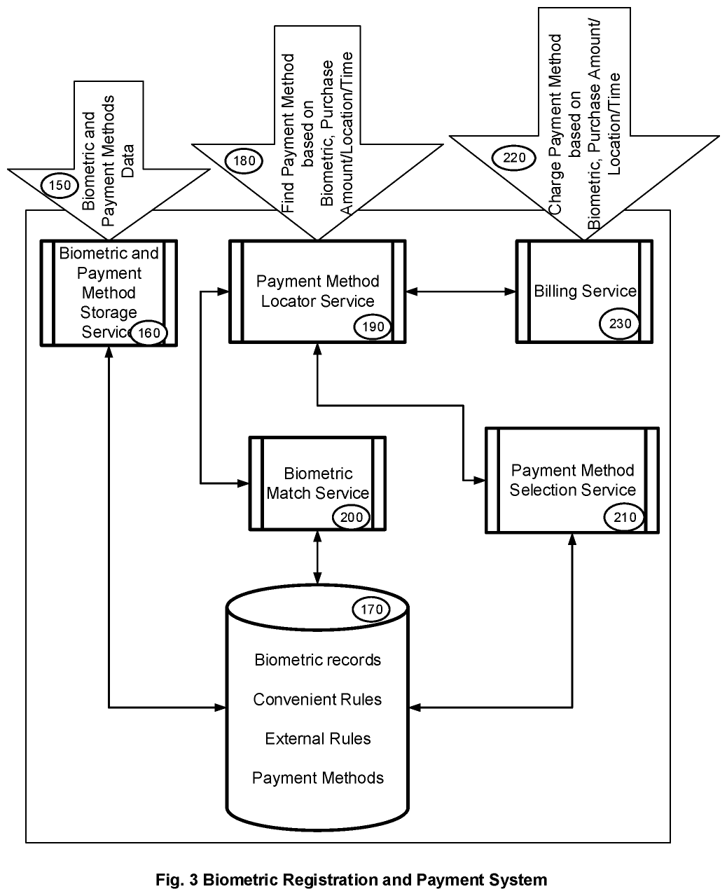

FIG. 3 depicts one possible design of the Biometric Registration and Payment System. At the time of registration and prior to the first purchase, the Biometric Registration and Payment System receives biometric representation data in addition to the payment methods information (1 50). The Biometric and Account Storage Service (160) receives and stores the biometrics, payment methods and rules information into the database (1 70). At the time of purchase, the Biometric Registration and Payment System can provide two services. The first service provided by the system is when a request is received to find the associated payment method given a biometric, purchase amount, purchase time and purchase location (180). The Payment Method Locator Service (190) first uses the Biometric Match Service (200) to find the stored biometric record with biometric representation data that matches the received biometric representation data. The Payment Method Locator Service (190) then uses the found biometric record to call the Payment Method Selection Service (210) that in turn finds and executes the stored convenient and external rules and returns the associated payment method information whether it is a financial card or account. The second service provided by the Biometric Registration and Payment System is when a request is received to charge the associated payment method given a biometric, purchase amount, purchase time and purchase location (220). The Billing Service (230) uses the Payment Method Locator Service (190) to find the associated payment method and consequently charges or debits the found card or account and returns status.

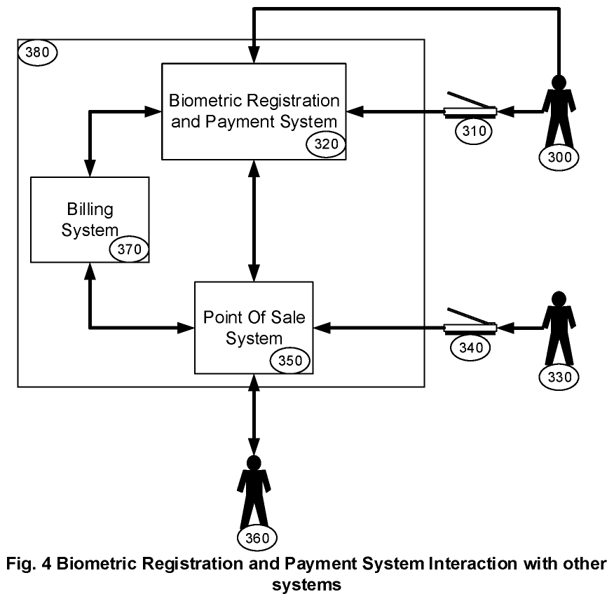

FIG. 4 depicts one interaction design of a Biometric Registration and Payment System with other systems. At the time of biometrics and account registration, the buyer (300) scans his biometric using a biometric reader (310) where the biometric representation data are stored in the Biometric Registration and Payment System (320). The buyer (300) manages his payment methods in addition to the convenient rules using the Biometric Registration and Payment System (320). At the time of purchase, the operator of the POS System (360) enters the purchase amount into the POS System (350). The buyer (330) starts by scanning his biometric using a biometric reader (340) that sends the biometric representation data to the Biometric Registration and Payment System. The biometric data and purchase amount along with other information such as the purchase location and time of purchase are processed by the Biometric Registration and Payment System (320). If the POS System (350) is processing the billing then it requests the associated payment method information whether it is a financial card or account information from the Biometric Registration and Payment System (320). If the Biometric Registration and Payment System (320) is processing the billing then it returns a status to the POS System (350). In either case, the Billing System (370) is called to charge or debit the financial card or account as appropriate. The three systems namely the Biometric Registration and Payment System (320), the POS System (350) and the Billing System (370) could be separate or part of a large system (380) and the patent does not limit how such systems are micro designed and implemented. However, the patent outlines the main task of the Biometric Registration and Payment System to find the appropriate payment method and charge a payment method based on a biometric provided at the time of purchase without the need for buyers to provide payment method information at the time and location of purchase.

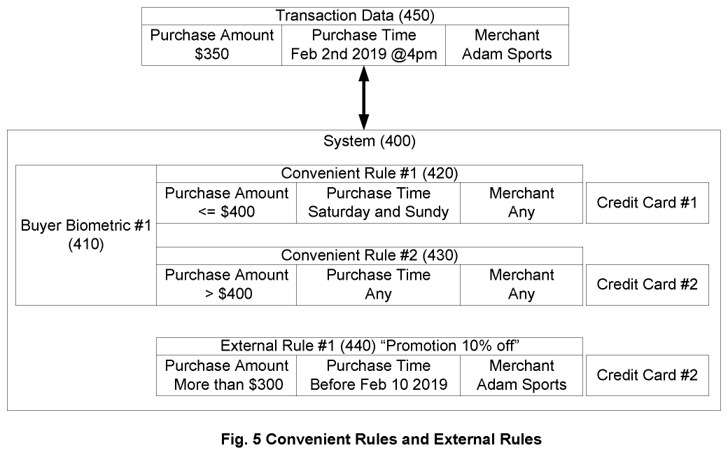

FIG. 5 depicts one example of how the convenient rules and external rules can be evaluated. A buyer has registered his biometric (410) with the System (400) and has related that biometric record (410) to two convenient rules (420) and (430) where convenient rule #1 (420) is satisfied and credit card #1 is selected when the purchase amount is <=$400 during Saturday and Sunday for any merchant and convenient rule #2 (430) is satisfied and credit card #2 is selected when the purchase amount is >$400. If the buyer has not enabled external rules, then when transaction data (450) is received at the time of purchase then convenient rule #1 is satisfied and hence credit card #1 is selected. However, if the buyer enables external rules to be evaluated first then external rule #1 (440) which is a 10% off promotion is satisfied and credit card #2 is selected where the buyer will not miss out on that promotion.

What is claimed is:

1. A method for providing flexible payments to allow buyers to pay merchants using biometrics of buyers and previously registered convenient rules without the need to carry and present financial payment methods [such as debit and credit cards] at the time and location of purchase, comprising: (a) a buyer registers one or more said biometrics where a biometrics in machine readable form is called a biometric record; (b) a buyer registers one or more said financial payment methods that can be debited; (c) a list of said merchants exists where each merchant has one or more merchant location records and each said merchant location record is related to a financial account that can be credited; (d) a buyer registers one or more said convenient rules prior to the first purchase where each rule is comprised of: a conditional component with one or more conditions for defining which said merchant location records a buyer plans to purchase from, what range of purchase amounts are allowed and when the purchase is allowed; and an action component with at least one action for defining which said registered financial payment methods should be selected to pay for the purchase at the time of purchase when said conditional component is satisfied; (e) a buyer relates one or more said registered biometric records to one or more said registered convenient rules prior to the first purchase using said method; and (f) at the time of purchase, transaction information including said biometric record of the buyer, said merchant location record, the time and amount of purchase is used to select one or more of said registered financial payment methods, comprising the steps of: comparing said biometric record of the buyer at the time of purchase with all said registered biometric records to find a matching biometric record; evaluating said conditional components of said registered convenient rules related to said matched biometric record by comparing said transaction information to said conditional components; and evaluating the action component of only one said convenient rule where said conditional component is satisfied to select one or more of said registered financial payment methods on behalf of the buyer.

2. The method of claim 1 wherein selecting one or more of said registered financial payment methods on behalf of the buyer at the time of purchase further comprises debiting one or more of said registered financial payment methods with said amount of purchase as defined by the buyer in said action component of said convenient rule and crediting said financial account related to said merchant location record with said amount of purchase to complete the purchase on behalf of the buyer at the time of purchase.

3. The method of claim 1 wherein the purchase is further not allowed when none of said conditional components of said registered convenient rules are satisfied or more than one said conditional component of said registered convenient rules are satisfied.

4. The method of claim 1 wherein said merchant location record further includes information necessary to identify each said merchant such as a tax identification number, a merchant address or a unique identifier.

5. The method of claim 1 wherein said action component of said registered convenient rule further comprises one or more said registered financial payment methods that are selected to pay for the purchase at the time of purchase and the buyer must define how to divide the purchase amount between said registered financial payment methods when registering said convenient rules.

6. The method of claim 1 wherein said transaction information at the time of purchase further does not include information on any financial payment methods and the buyer does not provide any financial payment methods at the time of purchase.

7. A system for providing flexible payments to allow buyers to pay merchants using biometrics of buyers and previously registered convenient rules without the need to carry and present financial payment methods [such as debit and credit cards] at the time and location of purchase, comprising: (a) means to allow a buyer to register and store one or more said biometrics prior to any purchase using said system where a biometric in machine readable form is called a biometric record; (b) means to allow a buyer to register and store one or more said financial payment methods that can be debited; (c) means to store a list of said merchants where each merchant has one or more merchant location record and each said merchant location record is related to a financial account that can be credited; (d) means to allow a buyer to register and store said convenient rules prior to the first purchase where each rule is comprised of: a conditional component with one or more conditions for defining which said merchant location records a buyer plans to purchase from, what range of purchase amounts are allowed and when the purchase is allowed; and
an action component with at least one action for defining which said registered financial payment methods should be selected to pay for the purchase at the time of purchase when said conditional component is satisfied; (e) means to store and evaluate external rules to validate financial transactions at any time as determined by parties other than buyers such as the account issuing entity or owners of said system; (f) means to allow a buyer to relate one or more said registered biometric records to one or more said registered convenient rules prior to the first purchase using said system; (g) means to receive transaction information at the time of purchase including said biometric record of the buyer, said merchant location record, the time and amount of purchase; and (h) means to select one or more said registered financial payment methods at the time of purchase, comprising the steps of: comparing said biometric record of the buyer at the time of purchase with all said registered biometric records to find a matching biometric record; evaluating said conditional components of said registered convenient rules related to said matched biometric record by comparing said transaction information to said conditional components; and evaluating the action component of only one said convenient rule where said conditional component is satisfied to select one or more of said registered financial payment methods on behalf of the buyer.

8. The system of claim 7 wherein selecting one or more of said registered financial payment methods on behalf of the buyer at the time of purchase further comprises debiting one or more of said registered financial payment methods with said amount of purchase as defined by the buyer in said action component of said convenient rule and crediting said financial account related to said merchant location record with said amount of purchase to complete the purchase on behalf of the buyer at the time of purchase.

9. The system of claim 7 wherein the purchase is further not allowed when none of said conditional components of said registered convenient rules are satisfied or more than one said conditional component of said registered convenient rules are satisfied.

10. The system of claim 7 wherein said external rules can be promotions or special discounts from the account issuing entity of said registered financial payment methods or from owners of said system or from said merchants or a third party where each rule is comprised of: a conditional component with one or more conditions for defining which said merchant location records are eligible for the promotion or special discount, what range of purchase amounts are eligible and when the purchase is allowed; and an action component with at least one action for defining which said registered financial payment method should be selected to pay for the purchase at the time of purchase when said conditional component is satisfied.

11. The system of claim 7 wherein said system provides means for the buyer to allow external rules to be evaluated before any registered convenient rule at the time of purchase and not to evaluate any registered convenient rule when the conditional component of an external rule is satisfied.

12. The system of claim 7 wherein said system is further able to communicate with account issuing entities of said registered financial payment methods and owners of said system for latest external rules.

13. The system of claim 7 wherein said system is further able to list external rules for the buyer at any time and give the buyer the ability to set preferences on the order of said external rules.

14. The system of claim 7 wherein said system is further able to communicate with or can be part of payment systems of financial clearing houses and payment systems owned by financial account issuing entities.

15. The system of claim 7 wherein said system is further able to communicate with or can be part of the point of sale (POS) system at the purchase location where the purchase amount is initially calculated and the biometric is read at the time and location of purchase.
